(19) United States
(12) Patent Application Publication
(10) Pub. No.: US 2002/0016767 A1
(43) Pub. Date: Feb. 7, 2002

(54) Automated bill paying system

(76) Inventor: Ervin F. Johnston, El Cajon, CA (US)

Correspondence Address: Ervin F. Johnston, 1904 Ventana Way, El Cajon, CA, 92020, US

(21) Appl. No.: 09/777,473

(22) Filed: Feb. 6, 2001

Related U.S. Application Data
(60) Provisional application No. 60/181,748, filed on Feb. 11, 2000.

(51) Int. Cl. G06F 17/60

(52) U.S. Cl. 705/40

(57) ABSTRACT

A creditor has provision for sending transaction data including amount due data to a debtor's E-Mail address. A computer at the debtor's site receives the transaction data with the amount due data and displays an amount due in a line item on an electronic video screen for approval by the debtor. The computer is responsive to an act by the debtor which indicates approval by the debtor of the amount due and sends approval data of the amount due to a bank's E-Mail address where the debtor has a bank account for paying bills. At the bank site the bank has a computer for receiving the approval data of the amount due and debits the bank account by the amount due and sends credit amount data to the creditor's E-Mail address which at least partially satisfies the amount due by the debtor. At the creditor's site a computer receives the credit amount data and credits the debtor's account by at least a portion of the amount due. At the debtor's site the debtor can select a line item that corresponds to an item number, a category column in the selected line item, insert a category item in the category column, sort the line items by categories and then display the result on a video screen.

### BACKGROUND OF THE INVENTION

1. Field of the Invention

The present invention relates to an automated bill paying system and, more particularly, to a system wherein a creditor electronically sends amount due data to the debtor where the debtor displays the amount due data on a video screen, approves the amount due and sends amount due approval data to the bank which debits an account of the debtor and electronically sends to the creditor a credit amount offsetting the amount due.

2. Description of the Related Art

A debtor typically receives numerous bills from creditors in the mail which require payment immediately or within a certain set period of time. Typically a debtor accumulates a stack of bills and sits down with a checkbook for the purpose of writing checks to satisfy the bills. This operation requires the debtor to check the amount due on the bill with an invoice or sales slip regarding a transaction with the creditor or remembering the transaction to confirm that the amount due is correct. This can be a problem if the invoice has been lost or misplaced and the debtor cannot recall the transaction with the creditor. After confirming that the amount due is correct the debtor typically writes a check for the amount due, joins the check with the bill or invoice from the creditor, places the bill and check into an envelope, writes the address of the creditor on the envelope, places a stamp on the envelope, travels to a location where there is a mail pick-up and then deposits the envelope, thus mailing payment to the creditor. The creditor typically opens the envelope, checks to ensure that the debtor has satisfied the amount due, credits the debtor's account related to the transaction, places the check along with other checks that are to be deposited in a bank account of the creditor and eventually takes the check along with the other checks to the creditor's bank for depositing to the creditors account.

After the end of the year the debtor reviews his invoices and checks for tax purposes. This is done for the purpose of itemized deductions as well as other tax deductions such as business enterprises, real estate rentals and stock transactions. Collecting all of the information required for supporting these deductions can be a time-consuming operation. Records of deductible expenses lost or misplaced must be omitted from entry on tax forms. There is a strong-felt need for facilitating the paying of bills and automatically categorizing the bills for tax purposes.

### SUMMARY OF THE INVENTION

The present invention involves a system for paying bills involving a creditor, a debtor and a bank that have a creditor E-Mail address, a debtor E-Mail address and a bank E-Mail address, respectively, at a creditor site, a debtor site and a bank site, respectively, wherein the creditor's site has stored transaction data which includes the debtor's E-Mail address and amount due data in a debtor's account. The creditor has provision for sending the transaction data including the amount due data to the debtor's E-Mail address. The computer is at the debtor's site for receiving the transaction data with the amount due data and displaying an amount due in a line item on an electronic video screen for approval by the debtor. The computer is responsive to an act by the debtor which indicates approval by the debtor of the amount due and sends approval data of the amount due to the bank's E-Mail address where the debtor has a bank account for paying bills. At the bank site the bank has a computer for receiving the approval data of the amount due and debits the bank account by the amount due and sends credit amount data to the creditor's E-Mail address which at least partially satisfies the amount due by the debtor. At the creditor's site a computer receives the credit amount data and credits the debtor's account by at least a portion of the amount due.

The transaction data may further include a description of a service and/or a product along with a date of the service and/or a date of the purchase of the product which is sent by the creditor and received by the debtor and displayed on the debtor's video screen for information purposes. In a preferred embodiment a voice activation device is connected to the debtor's computer for activating a selected line item when the debtor speaks an item number command and the debtor's computer sends the amount due approval to the bank of the amount due in the selected line item when the debtor speaks a send voice command.

Each line item on the debtor's video screen may have a column for a category item which may be selected from a group of category items which may be listed on the video screen. In a preferred embodiment the debtor highlights the selected line item with his item number voice command and then speaks a category item number voice command for a selected category item which inserts that category item in the category item column in the selected line item. The group category items may contain such items as real estate property tax, expenses on a rental, auto expenses and charitable contributions. The debtor's system has a sorting program for sorting the line items by the line items and displaying the line items by categories on the video screen. In the preferred embodiment this operation is also accomplished by voice activation wherein the debtor speaks a sort command which will sort all of the line items by category or by speaking a limited sort command which sorts line items only by one or more selected category items. In a preferred embodiment the bank also has account balance data which the debtor can call up on his screen to determine his bank balance before paying bills. Several banks may be involved in the system wherein the debtor may select a particular bank for paying his bill, and the creditor may be employed for sending confirmation paid data to the debtor so that the debtor knows that the debt has been paid by the bank.

An object of the present invention is to provide an automated system for paying bills involving a creditor, a debtor and a bank wherein the bill paying is accomplished electronically without the need of writing checks and mailing bills to the creditor.

Another object is to provide a system wherein bills due are displayed as line items on a video screen for the debtor and, after the amount due in a line item is approved by the debtor, approval is electronically sent to a bank by the debtor ordering the bank to pay the creditor the amount due.

A further object is to provide in addition to the previous objects a column for a category in each line item, a selection of category items where the debtor can select a category item to be inserted in the column, a sort program which allows the debtor to sort line items by categories and display the information on a video screen.

Still another object is to accomplish any one or combination of the previous objects by a voice activation device wherein the debtor speaks commands which implements the various functions.

Other objects and attendant advantages of the present invention will be apparent after reading the following description taken together with the accompanying drawings.

### BRIEF DESCRIPTION OF THE DRAWINGS

FIG. 1 is a block diagram of the present automated bill paying system;

FIG. 2 is a block diagram of an exemplary communication scheme for the present invention;

FIG. 3 is a block diagram of a portion of the system located at a creditor's site;

FIG. 4 is a block diagram of the portion of the system located at the debtor's site;

FIG. 5 is a block diagram of a portion of the automated system at the bank's site.

FIG. 6 is an exemplary illustration of the debtor's video screen after sorting line items by categories;

FIG. 7 is a block diagram of exemplary components employed at the debtor's site; and

FIG. 8 is an isometric illustration of a recorded disk containing data which is used within a computer at the debtor's site;

### DESCRIPTION OF THE PREFERRED EMBODIMENT

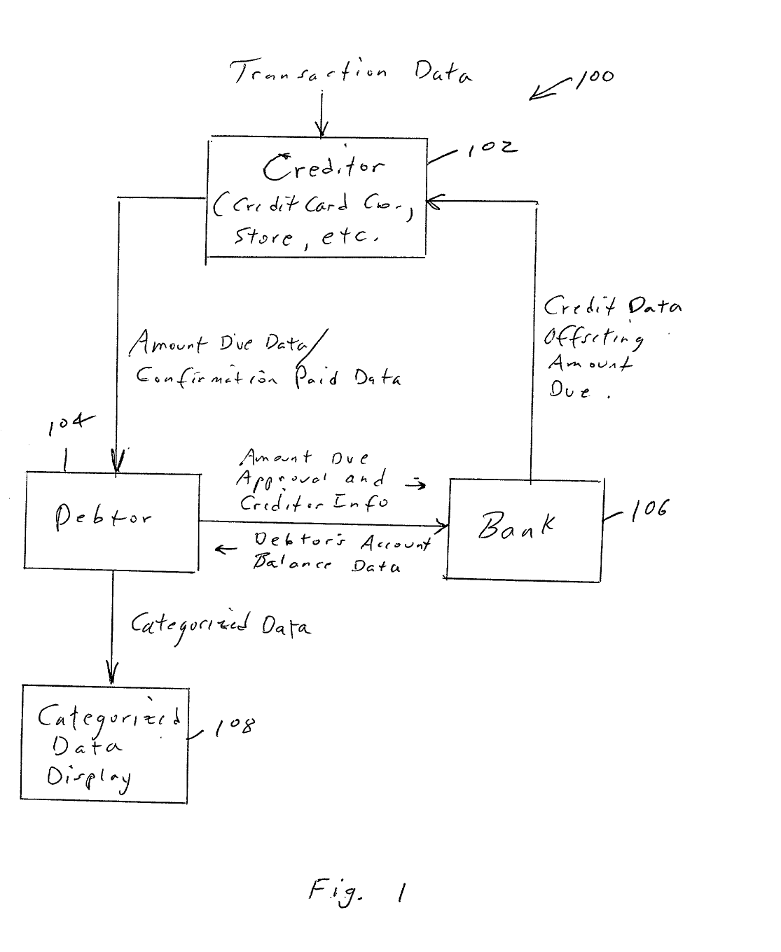

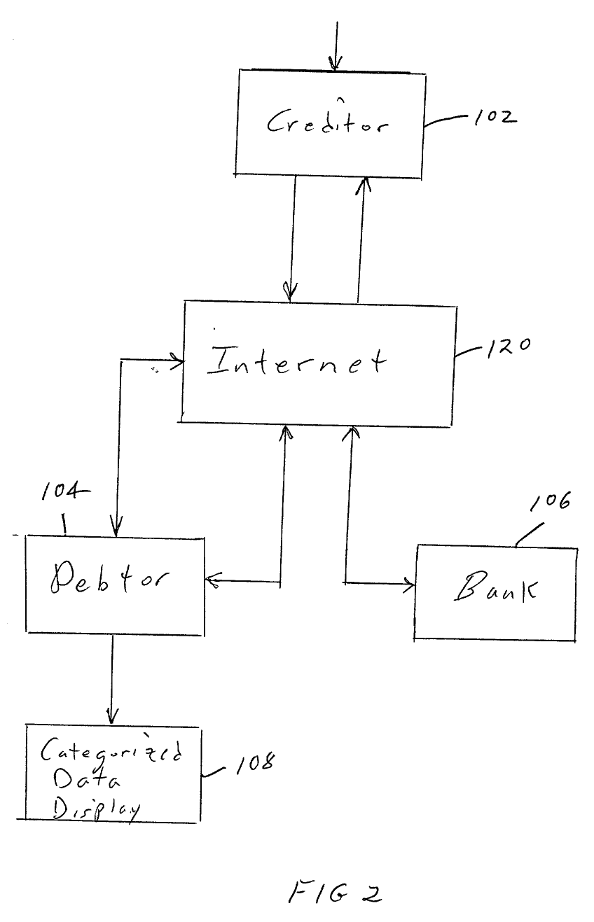

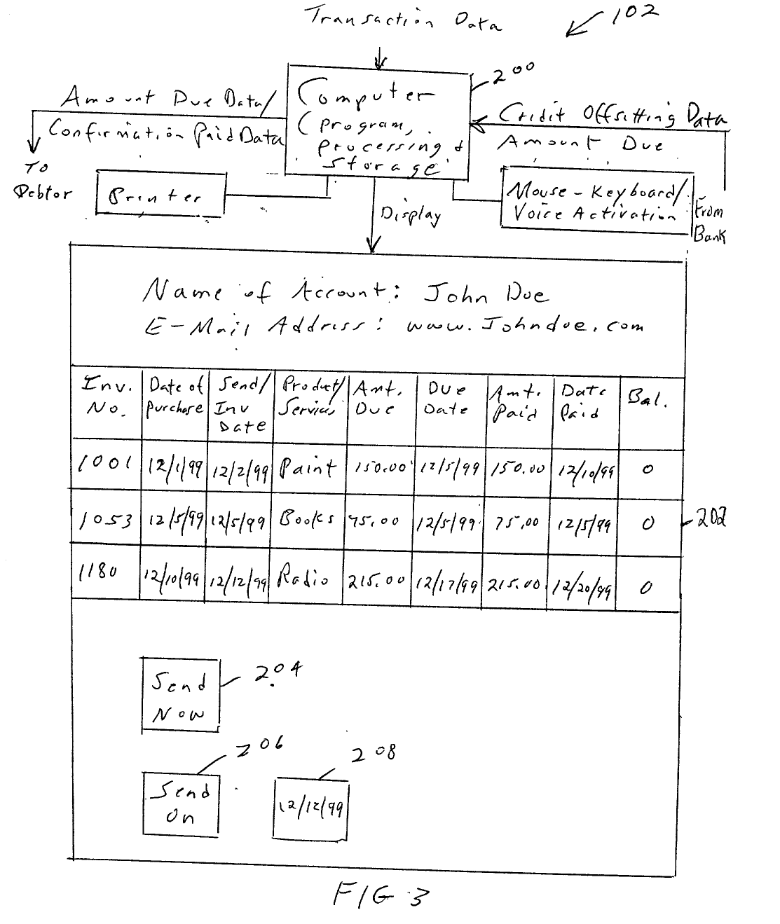

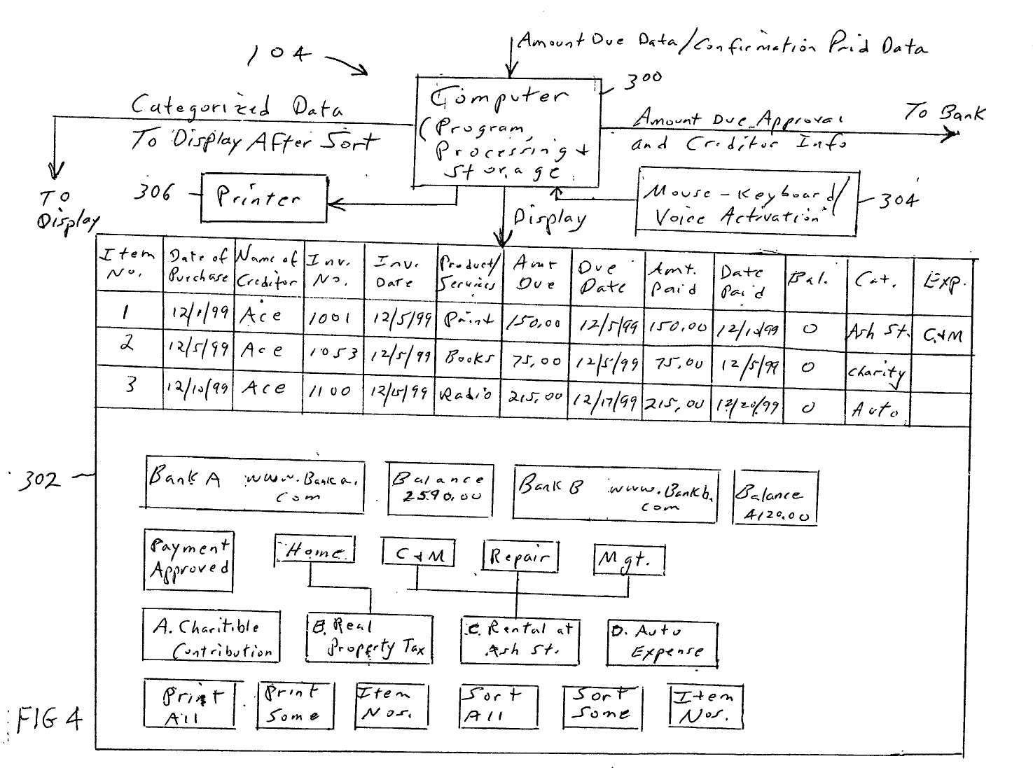

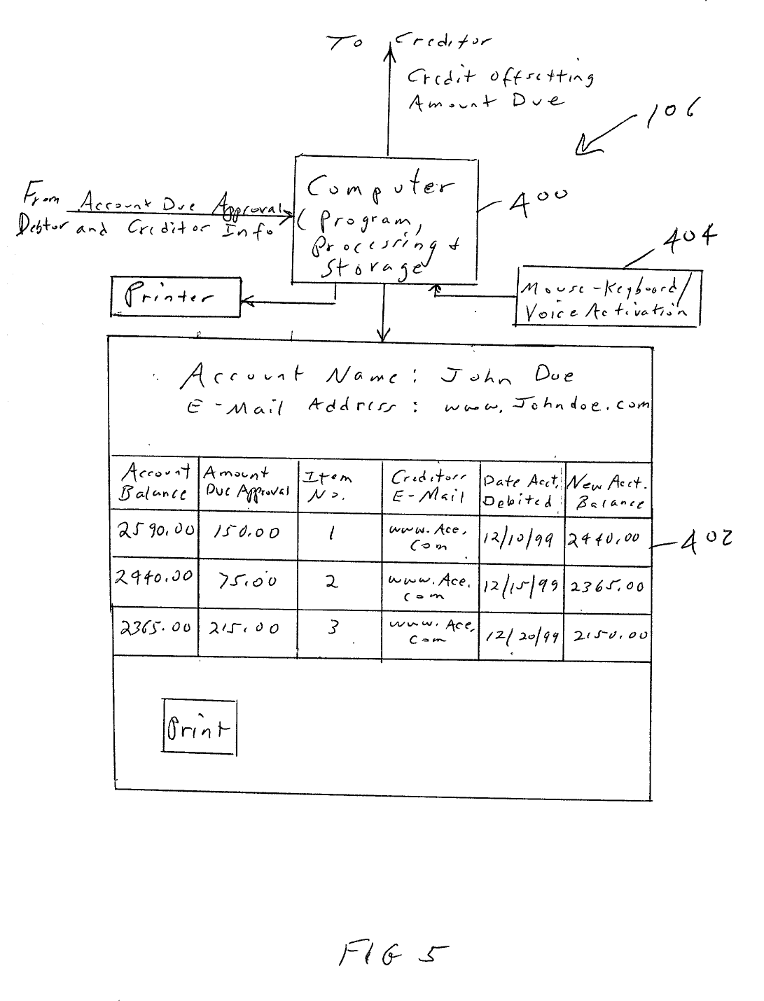

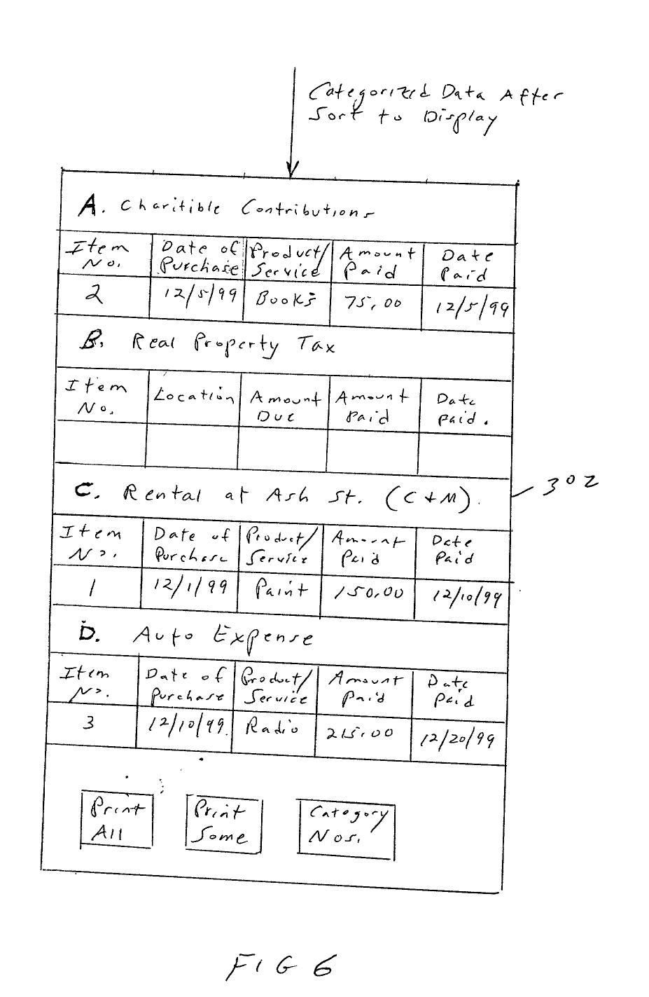

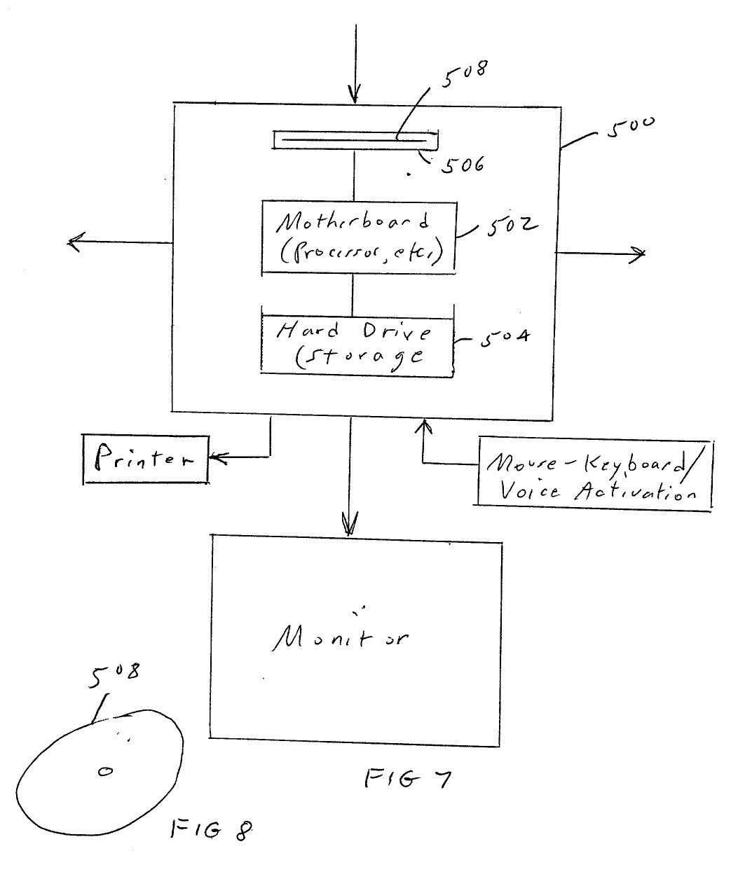

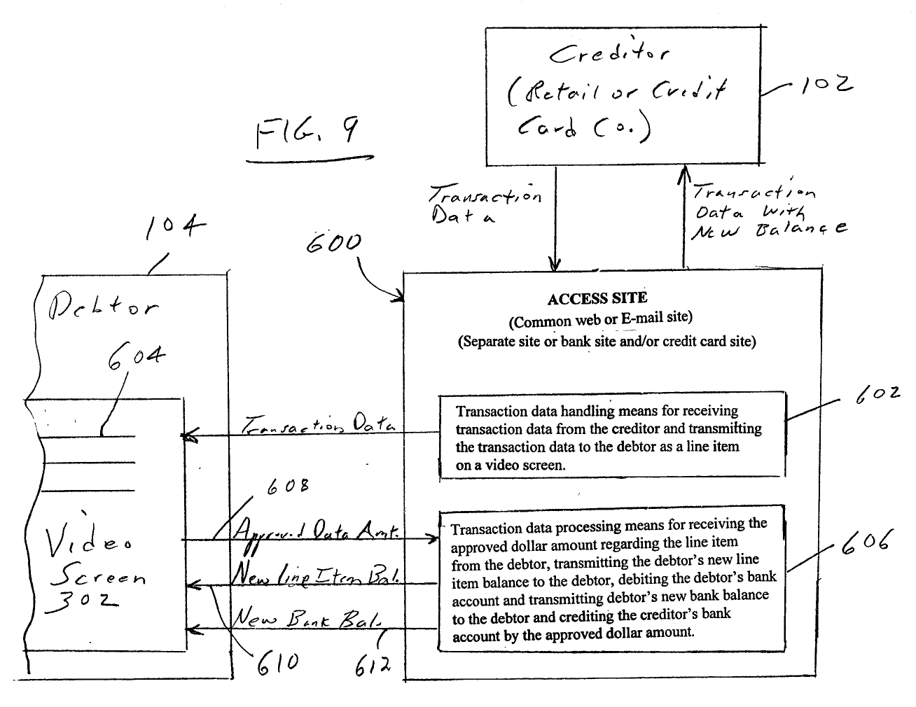

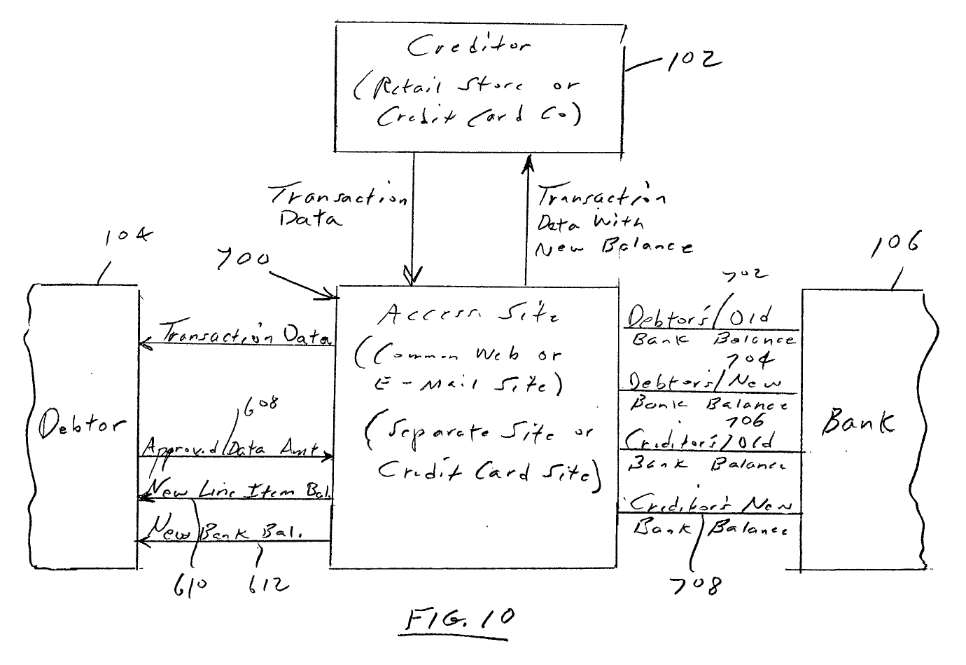

Referring now to the drawings wherein like reference numerals designate like or similar parts throughout the several views there is shown in FIG. 1 an automated bill paying system 100 which involves a creditor at a creditor's site 102, a debtor at a debtor's site 104 and bank at a bank site 106. The debtor has had a transaction with the creditor involving the purchase of goods or services which has generated transaction data or optionally the debtor may have used his credit card in a transaction and the credit card company is now the creditor of the debtor. The transaction data may be generated by information taken by a sales clerk or other means such as pre-arranged orders, ordering over the internet or ordering by phone or facsimile. In any event, the creditor has amount due data stored which is sent to the debtor for payment at the debtor's site 104. The debtor displays the amount due data in a line item on a video screen, which will be explained in more detail hereinafter, and after approval, the debtor sends amount due approval data to the bank site 106 where the debtor has a bank account for paying bills. The bank then sends credit data offsetting the amount due to the creditor's site 102 where the creditor credits the debtor's account for at least partially satisfying the amount due. The creditor may further send confirmation paid data to the debtor at the debtor's site 104 indicating to the debtor that the bill has been paid. Further, the bank may send account balance data to the debtor's site 104 so that the debtor may confirm the account balance in his bank before he sends approval of the amount due to the bank site 106. In a preferred embodiment the debtor can categorize line items on his video screen which are categorized by a sort function and displayed by categories on a display screen 108.

FIG. 2 shows an exemplary system for sending and receiving data between the creditor, debtor and bank sites 102, 104 and 106. In a preferred system the data items are sent and received via at least one internet provider 120, wherein each of the creditor, the debtor and the bank 102, 104 and 106 can access data and send data to the other via the internet provider 120. Optionally, additional internet providers may be employed wherein one of the sites has a separate internet provider or optionally each of the sites 102, 104 and 106 may have a separate internet provider. While sending and receiving of data may be via one or more internet providers, it should be understood that the sending and receiving of data can be by other systems such as electronic transmission directly between the sites 102, 104 and 106 without an intermediate internet provider, through various mediums such as electromagnetic transmission with or without satellite assistance, phone lines or cable lines. A preferred sending and receiving of data is wireless transmission of such data directly between the sites.

### Creditor's Site

FIG. 3 illustrates a block diagram of the creditor's site 102 which includes a computer 200 for receiving the transaction data, sending the amount due data and/or the confirmation paid data to the debtor, receiving the credit offset data from the bank and implementing a display of the various data on a video display 202. In a preferred embodiment computer functions are implemented by a voice activation device which is connected to the computer. Alternatively, the computer functions may be activated by a mouse and keyboard connected to the computer. In the display an exemplary name of the account is “John Doe” who is the debtor at the debtor's site 104 in FIG. 2. His E-Mail address is displayed as “www.johndoe.com”. For each transaction the display may show information in the transaction data such as Invoice Number, Date of Purchase, Product and/or Services and Amount Due. In addition, the screen 202 may display “Send/Invoice Date” which is a date that the invoice is to be sent to the debtor, Due Date of the amount owing, Amount Paid by the debtor, the date paid by the debtor and the Balance due. These latter items may be inserted into the appropriate locations for each of the invoices numbered 1001, 1053 and 1180 by the creditor's use of the voice activation device and/or the mouse and keyboard. For instance, the creditor may speak an invoice number command which activates the line item represented by invoice number 1001, speak a send/invoice date command which activates the send/invoice date column, speak the date Dec. 2, 1999 and then speak a send command which sends the amount due in the amount due column to the debtor for payment. In a similar manner the due date Dec. 5, 1999 in the line item 1001 can be inserted by voice activation.

The information shown on the Amount Paid, Date Paid and Balance columns is preferably automatically inserted upon receipt of the credit offsetting data from the bank by a computer program. In a preferred embodiment the amount due data sent by the computer 200 at the creditor's site will send the Invoice Number, the Date of Purchase, the Product and/or Services and the Amount Due data to the debtor. Invoice numbers 1053 and 1180 are other invoices for the debtor John Doe and are represented as line items on the video screen 202. The invoices numbered 1001, 1053 and 1180 are for paint, books and a radio, respectively, which can be categorized by the debtor which will be explained in more detail hereinafter. It should be understood that if a mouse and keyboard are employed instead of a voice activation device that the mouse can be employed for activating a line item, such as line items 1001, and a send button 204 or a send on button 206 with the date typed by the keyboard in button 208, such as Dec. 12, 1999.

### Debtor's Site

A block diagram for the debtor's site 104 is illustrated in FIG. 4 wherein a computer 300 is employed for entry and storage of amount due data and confirmation paid data, for sending amount due approval and creditor information to the bank site after the debtor has approved an amount due, displaying the amount due as well as other data items on a video screen 302 and sending categorized data to the display after a sorting operation by the computer, which will be discussed in more detail hereinafter. Computer functions are preferably controlled by voice activation but, optionally, can be controlled by a mouse and keyboard which are represented at 304 and which are connected to the computer 300. The amount due data received by the computer 300, which includes at least the amount due, is displayed by the computer in the amount due column in a line item such as line item number 1 shown in the item number column. Preferably the amount due data received by the computer 300 also includes Date of Purchase, Name of Creditor, Invoice Number, Invoice Date, Product and/or Services and Due Date which is displayed by the computer 300 in the respective columns in the video screen 302 in the pertinent line items which are numbered in the item number column. It can be seen for the line item for invoice 1001 in the creditor's screen 202 in FIG. 3 that the date of purchase on Dec. 1, 1999 the product is paint, the amount due of $150.00 and the due date of Dec. 5, 1999 appears in the Date of Purchase, Product and/or Services, Amount Due and Due Date columns in item number 1 of the debtor's screen 302 in FIG. 4. Additional columns for the line items 1, 2 and 3 are Amount Paid, Date Paid, Balance, Category and Expense which will be discussed in more detail hereinafter. Below the line items on the screen 302 are buttons for Bank A and Bank B with each bank having a button for its E-Mail address and a location for the balance that the debtor has on credit in his bank balance. Below the banking line is a button for payment approved.

Below payment approved are category buttons A, B, C and D which represent, for instance, various categories such as charitable contributions, real property tax, rental at Ash Street and auto expense respectively. An exemplary button subordinate to the real property tax button is an expense button designated as “home” for tax expenses that the debtor spends on his home. Exemplary expense buttons for the rental at Ash Street button are cleaning and maintenance (C & M), Repair and management (Mgt.). On the last line are buttons for “print all” of the item numbers, “print some” of the item numbers with the item numbers typed into an item numbers location, a “sort all” button for sorting all of the item numbers 1, 2 and 3 by categories and expense as shown in the category and expense columns for the item numbers and the last button sorts the item numbers by categories when the sort some button is clicked and the selected items are inserted in the last blank entitled items nos. Any line item can be selected by selecting the corresponding item number 1, 2 or 3. The selection of the line items can be implemented by a mouse which is employed for clicking on a selected item number and any of the buttons below the line items 1, 2 and 3 can be selected by the mouse. In a preferred embodiment the debtor employs voice activation for implementing the computer functions by speaking commands. For instance, a voice command of “one” may be employed for activating the line item number 1 for processing.

In the operation of the system shown in FIG. 4 the debtor employs his computer for making the screen presentation shown in the video screen 302. He reviews items 1, 2 and 3 for payment and if he selects item number 1 for payment, he may say “item one” which activates the line item for item 1 or he may click item number 1 with his mouse. This then enables line item number 1 for processing by the debtor. The debtor may then desire to review his bank balance before making payment and this may be done by either saying “Bank A” or “Bank B” or clicking on the Bank A or Bank B button with his mouse. This will automatically send a request for the bank balance to the selected bank via E-Mail whereupon the bank's computer will automatically send the balance via E-Mail to the debtor's computer whereupon the balance will be displayed in the balance button. If the debtor is satisfied with his balance he may say “payment approved” or click the payment approved button with his mouse whereupon the debtor's computer 300 will send amount due approval data to the bank's computer via E-Mail. The remainder of the buttons on the debtor's video screen 302 will be discussed in more detail hereinafter.

### Bank's Site

FIG. 5 shows the bank's site 106 which includes a computer 400 wherein the computer 400 receives the account due approval and creditor info data from the debtor, optionally displays the data in a video screen 402 and sends credit offsetting amount data to the creditor at the creditor's E-Mail address. The account due approval data received from the debtor includes the amount due approved by the debtor which may be displayed in an Amount Due Approval column on the video screen. The creditor's info includes the creditor's E-Mail address which is displayed in the creditor's E-Mail column in video screen. Further, the account due approval preferably includes the item number involved which item numbers are listed in the Item Number column in the debtor's screen and also listed under the Item Number column in the bank's video screen. The item number then establishes a line item for the bank which also includes the Account Balance which is the bank balance in bank A before paying item number 1. The video screen may also receive information from the computer 400 which displays the account name as John Doe and John Doe's E-Mail address. Preferably, when the computer receives the account due approval and creditor information data, the computer 400 automatically sends the amount approved by the debtor as credit offsetting amount due data to the E-Mail address of the creditor, provided the debtor has a sufficient bank balance. Simultaneously, the columns entitled “Date Account Debited” and “New Account Balance” may be completed showing that the account was debited for item number 1 on Dec. 10, 1999 and that the new account balance is $2,440.00. This new account balance would then be the information that the debtor would receive if he activated the Bank A button in his video screen 302. Optionally, a mouse and keyboard and/or a voice activation device 404 may be connected to the computer 400 for printing one or more of the item numbers 1, 2 and 3 by utilizing the mouse and keyboard with a “print” button on the video screen or simply voice activating the operation by voice commands. When the creditor receives the credit offset data from the bank, as shown in FIG. 3, the creditor's computer 200 may automatically complete the items shown under the Amount Paid, Date Paid and Balance columns shown for the particular invoice that is being paid. This then generates confirmation paid data within the computer which can be sent to the debtor which appears in the Amount Paid, Date Paid and Balance columns in the debtor's screen 302 for the particular item number that has been paid. Accordingly, once the debtor has commanded the bank to make payment the whole operation can be instantaneous so that the debtor receives almost immediately confirmation that the bill has been paid by looking at the balance column on his video screen.

### Sorting at Debtor's Site

A feature of the invention is that the debtor can organize his payments for items 1, 2 and 3 in FIG. 4 for accounting purposes, such as that required for income tax forms. As an example, the debtor can activate a particular line item by simply employing the voice activation device and saying “item one” or by clicking on the corresponding item number in the item number column. The debtor then selects the column category by saying “category” and then selects a category, such as Ash St. by saying “C” whereupon Ash St. is inserted in the category column. Optionally, the debtor uses his mouse to click on the category column and then clicks on one of the categories A, B, C or D, such as category C for the “Rental at Ash St.” or by simply says category A, B, C or D, such as saying “Category C” for the “Rental at Ash St.” For instance, if line item number 1 is selected and the debtor says “Category C”, “Ash Street” will appear under the category column in line item number 1. The debtor may further select cleaning and maintenance (C & M) by saying “C and M” or by clicking on C and M, then C and M will appear under the expense column in line item number 1. Optionally, if the product or services under the Product/Services column qualified as repair or management then one of these items would be selected by voice activation or by the mouse to appear under the expense column for item number 1. As a further example, if line item number 2 and charitable contribution is selected then something like charity would appear under the category column for line item number 2. If line number 3 and auto expense are selected then something like auto would appear under the category column for line item number 3. Once this is accomplished the debtor may then select the sort all function by saying “sort all” or by clicking on the Sort All button which causes the computer to sort items 1, 2 and 3 by the category items under the category column.

The result shows up on the video screen 302 in FIG. 6 taking the place of the information shown on the video screen 302 in FIG. 4. After sorting, the video screen 302 in FIG. 6 shows the result of the sort as Item Number 2 under Charitable Contributions, nothing under Real Property Tax, Item Number 1 under cleaning and maintenance (C & M) for the Rental at Ash Street and Item Number 3 under Auto Expense. Each item number preferably displays Date of Purchase, Product and/or Service, Amount Paid and date paid in respective locations for categories 1, 3 and 4 and category 2 preferably displays for each line item Location, Amount Due, Amount Paid and Date Paid. The screen 302 in FIG. 6 may have a print all button which may be clicked by a mouse or the debtor may simply say “print all” and may have a print some and category numbers buttons wherein the print some can be clicked by the mouse and category numbers typed in the category numbers location or the debtor may simply say “print some” and say the category numbers such as A, B, C or D.

Returning to the screen 302 in FIG. 4, the screen has a print all button which can be clicked by the mouse or the debtor may simply say print all whereupon each of the line items 1, 2 and 3 will be printed on a printer 306. The screen 302 may also contain a print some and item numbers button wherein the print some button may be clicked and item numbers typed in the item numbers button to print selected item numbers or the debtor may simply say “print some” following by saying selected item numbers whereupon the computer prints the selected line items to the printer.

### Discussion

An exemplary computer 500 for any one of the computers 200, 300 or 400 in FIGS. 3, 4 and 5 is shown at 500 in FIG. 7. The computer 500 in FIG. 7 includes a motherboard which has a processor for processing all of the incoming and outgoing data and has other components such as input and output ports. A hard drive 504, which may be a magnetic disk drive, is connected to the motherboard for storing the data. An exemplary disk drive 506 receives a recorded disk such as a magnetic disk or a CD ROM. The drive 506 is connected to the motherboard 502 so that the data on the disk 508 can be utilized by the motherboard for processing the incoming and outgoing data. The disk 508 is shown in isometric illustration in FIG. 8. A separate disk is preferably employed for each of the computers 200, 300 and 400 in FIGS. 3, 4 and 5 for implementing the processing of the present system described hereinabove for each of the creditor, debtor and bank sites. Accordingly, a disk for the computer 200 shown in FIG. 3 contains all of the commands required for causing the computer 200 to implement preferably all of the functions described and carried out by the computer 200 hereinabove, a disk for the computer 300 in FIG. 4 contains all of the commands required to cause the computer 300 to carry out preferably all of the functions described for FIGS. 4 and 6, and the disk for the computer 400 shown in FIG. 5 contains all of the commands required to cause the computer 400 to carry out preferably all of the functions described hereinabove for FIG. 5. Optionally, of course, any of these disks may include commands less than that required to carry out all of the functions provided the disk carries sufficient commands to carry out the payment of bills described hereinabove.

Clearly, other embodiments and modifications of this invention will occur readily to those of ordinary skill in the art in view of these teachings. Therefore, this invention is to be limited only by the following claims, which include all such embodiments and modifications when viewed in conjunction with the above specification and accompanying drawings.

I claim:

1. An apparatus for paying bills involving a creditor, a debtor and a bank that has a creditor E-Mail address, a debtor E-Mail address and a bank E-Mail address respectively at a creditor site, a debtor site and a bank site respectively comprising:
the creditor's site having stored transaction data which includes the debtor's E-Mail address and amount due data in a debtor's account of the debtor;
means, at the creditor's site, for sending the transaction data including the amount due data to the debtor's E-mail address;
computer means, at the debtor's site, for receiving the transaction data with the amount due data and displaying an amount due in the amount due data in a line item on an electronic video screen for approval by the debtor;
activation means interconnected to the computer means and responsive to a first approval command by the debtor for indicating approval by the debtor of at least a portion of the amount due;
upon the activation means responding to said first command, the computer means being responsive to the activation means for sending approval data of said at least a portion of the amount due to the bank's E-mail address where the debtor has a bank accoung for paying bills;
means, at the bank's site, for receiving the approval data of said at least a portion of the amount due data and debiting said bank account by said at least a portion of the amount due;
means, at the bank site, for sending to the creditor's E-Mail address credit amount data which includes said at least a portion of the amount due for offsetting said amount due; and
means, at the creditor's site, for receiving the credit amount data and crediting the debtor's account by said at least a portion of the amount due.

2. An apparatus as claimed in claim 1 further comprising:
the transaction data further including a description of a service and/or a product and a date of the service and/or date of purchase of the product;
said means at the creditor's site also for sending the transaction data which further includes the description of the service and/or the product and the date of the service and/or date or purchase of the product to the E-Mail address of the debtor; and
said computer means also for receiving the transaction data which further indicates the description of the service and/or the product and the date of the service and/or the date of purchase of the product and displaying the description of the service and/or the product and/or the date of the service and/or the date of purchase of the product in said line item on said screen.

3. An apparatus as claimed in claim 1 wherein the transaction data also includes a category item for each amount due and the computer means also receives the category item and displays the category item in said line item on the screen.

4. An apparatus as claimed in claim 1 further comprising:
the means for sending at the bank site calculates a debtor's account balance and sends debtor's account balance data to the E-Mail address at the debtor's site; and
the computer means also for receiving the account balance data and displaying the account balance on said screen.

5. An apparatus as claimed in claim 1 further comprising:
the activation means being responsive to a second approval command by the debtor for indicating payment of said at least a portion of the amount due on a selected date; and
upon the activation means responding to said second approval command, the computer means being responsive to the activation means for sending approval data of said at least a portion of the amount due to said bank's E-mail address on said selected date.

6. An apparatus as claimed in claim 5 wherein the voice activation means is responsive to a second voice approval command by the debtor which is said second approval command.

7. An apparatus as claimed in claim 5 wherein the activation means further includes:
a keyboard interconnected to the computer means;
the screen also having a send later button and a send on a date button interconnected to the computer means; and
said second approval command comprising clicking the send later button with the mouse and typing the selected date in the send on bottom with said keyboard.

8. An apparatus as claimed in claim 1 wherein the activation means includes voice activation means for receiving a first voice approval command by the debtor wherein the first voice approval command is said first approval command.

9. An apparatus as claimed in claim 8 further comprising:
each line item being interconnected to the computer means and having a first column for a first selected category item; and
the activation means being responsive to a first category command for including the first selected category item in said first category column.

10. An apparatus as claimed in claim 9 further comprising:
the voice activation means being responsive to a first category command which is said second category command.

11. An apparatus as claimed in claim 10 further comprising:
the computer means having a sorting means for sorting line items by category items and displaying the line items by categories on said screen.

12. An apparatus as claimed in claim 11 further comprising:
a printer at the debtor's site interconnected to the computer means;
the voice activation means being responsive to a first print voice command by the debtor indicating the debtor's approval to print all or selected items on the screen; and
upon the debtor saying the first print voice command, the computer means responding to the voice activation means to cause the printer to print all or selected items on the screen.

13. An apparatus as claimed in claim 1 wherein the activation means includes:
a mouse interconnected to the computer, which can be moved to click on selected portions of the screen;
the screen having a send now button interconnected to the computer means which, when clicked on by the mouse, causes the computer means to send said approval data of said at least a portion of the amount due to the E-mail address of the bank; and
said first approval command is clicking said send now button with said mouse.

14. An apparatus as claimed in claim 13 further comprising:
each line item being interconnected to the computer means and having a first category column for a first selected category item; and
the activation means being responsive to a first category command for including the first selected category item in said first category column.

15. An apparatus as claimed in claim 14 further comprising:
a clicking of the line item by the mouse readies the first category column for insertion of the first selected category item;
the screen having a plurality of category item buttons interconnected to the computer means which, when clicked by the mouse, inserts the first selected category item in the first category column; and
the clicking of the line item and the clicking of the selected category item being said first category command.

16. An apparatus as claimed in claim 15 further comprising:
the computer means having a sorting means for sorting line items by category items and displaying the line items by categories on said screen.

17. A computer program product for paying bills involving a creditor, a debtor and a bank with a creditor E-Mail address, a debtor E-Mail address and a bank E-Mail address respectively at a creditor site, a debtor site and a bank site respectively wherein the creditor's site has stored transaction data which includes the debtor's E-Mail address and amount due data in a debtor's account of the debtor and has means for sending the transaction data including the amount due data to the debtor's E-mail address and wherein the bank's site has means for receiving approval data of at least a portion of the amount due data and debiting said bank account by said at least a portion of the amount due and means for sending to the creditor's E-Mail address credit amount data which includes said at least a portion of the amount due for offsetting said amount due and wherein the creditor further has means for receiving the credit amount data and crediting the debtor's account by said at least a portion of the amount and wherein the computer program product is for use with a computer, a video screen and an activator at the debtor's site wherein the screen and the activator are interconnected to the computer and the activator is responsive to commands by the debtor for activating the computer to perform functions, said computer program product comprising:
a recording medium;
receiving means, recorded on the said recording medium, for receiving the transaction data with the amount due data and displaying an amount due in the amount due data in a line item on the video screen for approval by the debtor; and
approval means, recorded on said recording medium, for causing the activator to indicate approval by the debtor of said at least a portion of the amount due when the activator responds to a first approval command by the debtor; and
sending means, recorded on said recording medium, responsive to the indication of approval by the activator for causing the computer to send approval data of said at least a portion of the amount due to the bank's E-mail address where the debtor has a bank account for paying bills.

18. A computer program product as claimed in claim 17 wherein the transaction data further includes a description of a service and/or a product and a date of the service and/or date of purchase of the product and wherein the creditor has means for sending the transaction data which further includes the description of the service and/or the product and the date of the service and/or date or purchase of the product to the E-Mail address of the debtor, the computer program product further comprising:
the receiving means for receiving the transaction data which further indicates the description of the service and/or the product and the date of the service and/or the date of purchase of the product and displaying the description of the service and/or the product and/or the date of the service and/or the date of purchase of the product in said line item on said screen.

19. A computer product as claimed in claim 18 wherein the transaction data also includes a category item for each amount due, the computer product further comprising:
the receiving means further including means for displaying the category item in the line item on the screen.

20. A computer product as claimed in claim 17 wherein the means for sending at the bank site also calculates a debtor's account balance and sends debtor's account balance data to the E-Mail address at the debtor's site, the computer product further comprising:
the receiving means also for receiving the account balance data and displaying the account balance on said screen.

21. A computer program product as claimed in claim 17 further comprising:
the approval means further including means for causing the activator to indicate payment of said at least a portion of the amount due on a selected date when the activator responds to a second approval command by the debtor;
upon the activator responding to said second approval command by the debtor, the sending means further causing the computer means to send approval data of said at least a portion of the amount due to said bank's E-mail address on said selected date.

22. A computer program product as claimed in claim 21 wherein the activator is a voice activator and the second approval command is a second approval voice command.

23. A computer program product as claimed in claim 21 wherein the activator further includes the screen also having a send later button and a send on a date button interconnected to the computer, a mouse for clicking on the send later button and a keyboard for typing a date in the send on button wherein the second approval command is said clicking and said typing, the computer product further comprising:
the approval means further includes means for causing the activator to indicate payment of said at least a portion of the amount due on a selected date when the send on button is clicked and the selected date is typed in the send on button;
upon the activator indicating payment, the sending means further for causing the computer means to send approval data of said at least a portion of the amount due to said bank's E-mail address on said selected date.

24. A computer program product as claimed in claim 17 wherein the activator is a voice activator and said first approval command is a first voice approval command by the debtor which is received by the voice activator.

25. A computer product as claimed in claim 24 wherein the computer product further includes:
means, on said recording medium, for displaying a first category column in the line item for a first selected category item; and
category means, on said recording medium, and responsive to a first category command for inserting the first selected category item in said first category column.

26. A computer product as claimed in claim 25 wherein the computer product further comprises:
means, on the recording medium, for inserting the selected category item in the first category column when the debtor speaks the first category voice command to the voice activator wherein the first category voice command is said first category command.

27. A computer product as claimed in claim 26 wherein the computer product further comprises:
means, recorded on the recording medium, for sorting line items by category items and displaying the line items by categories on said screen.

28. A computer product as claimed in claim 27 wherein a printer is located at the debtor's site, the computer product further comprising:
print means, on the recording medium, for causing the computer to cause the printer to print all or selected items on the screen when the debtor speaks a first voice command to the voice activator.

29. A computer program product as claimed in claim 17 wherein the screen has a send now button interconnected to the computer and the activator includes a mouse interconnected to the computer which, when the send now button is clicked on by said mouse, is said first approval command.

30. A computer product as claimed in claim 29 the computer product further comprising:
means, on said recording medium, for displaying a first category column in the line item for a first selected category item; and
category means, on said recording medium, and responsive to a first category command for inserting the first selected category item in said first category column.

31. A computer product as claimed in claim 30 wherein the computer product further comprises:
the category means further including means for readying the category column for insertion of the selected category item when the line item is clicked by said mouse and for inserting the first selected category item in the first category column when the selected category item is clicked by said mouse wherein clicking of the line item and the clicking of the selected category item is said first category command.

32. A computer product as claimed in claim 31 wherein the computer product further comprises:
means, recorded on the recording medium, for sorting line items by category items and displaying the line items by categories on said screen.
